(19) United States
(12) Patent Application Publication
(10) Pub. No.: US 2025/0130543 A1
(43) Pub. Date: Apr. 24, 2025

(54) Method for Determining System Excitation by at Least One Input Signal for Model-Based Control of a Technical System

(71) Applicant: Robert Bosch GmbH, Stuttgart (DE)

(72) Inventors: Kevin Schmidt, Herrenberg (DE); Nicola Henkelmann, Vaihingen/Enz (DE); Ranbir Singh, Brackley (GB); Stefan Gruener, Auenwald (DE)

(21) Appl. No.: 18/914,081

(22) Filed: Oct. 12, 2024

(30) Foreign Application Priority Data
Oct. 19, 2023 (EP) 23204534.4

(51) Int. Cl. G05B 19/042

(52) U.S. Cl. CPC G05B 19/042; G05B 2219/23006

(57) ABSTRACT

A method for determining system excitation by at least one input signal for model-based control of a technical system includes (i) providing the at least one input signal, wherein the at least one input signal physically affects at least one parameter of the technical system, (ii) defining at least one distribution assumption for the at least one parameter, (iii) defining a target function for optimizing the at least one input signal taking into account the at least one defined distribution assumption, the target function optimizing the at least one input signal at least based on a weighting of a sensitivity of the input signal, (iv) determining a numerical algorithm for solving the defined target function and an uncertainty quantification method for determining the sensitivity of the at least one input signal, (v) optimizing the defined target function based on the determined numerical algorithm and the determined uncertainty quantification method, and (vi) determining the system excitation based on the optimized target function. A computer program, a device, and a storage medium for this purpose are also disclosed.

This application claims priority under 35 U.S.C. § 119 to patent application no. EP 23204534.4, filed on Oct. 19, 2023 in Europe, the disclosure of which is incorporated herein by reference in its entirety.

The disclosure relates to a method for determining system excitation by at least one input signal for model-based control of a technical system. The disclosure further relates to a computer program, a device, and a storage medium for this purpose.

### BACKGROUND

In the context of system identification in model-based control, system excitation is particularly important as it forms the basis for identifying the system parameters. By using various excitation or input signals, the behavior of the system can be investigated under various conditions. This data can then be utilized to create or calibrate a mathematical model of the system.

The quality of the system excitation may significantly affect the accuracy of the identified model. Suboptimal excitation may result in a model that is not sufficiently accurate to represent the actual dynamics of the system. Thus, it is critical to select an excitation that is informative enough to adequately map all relevant dynamics of the system.

The choice of system excitation is thus essential for the identification of model parameters. The quality of identifiability depends largely on the system input selected. Because the choice of excitation depends on various parameters of the control loop of the system, the question regarding the system excitation can be very system specific. There are extensive so-called “measurement catalogs” for system identification that are based on expert knowledge. Said catalogs are rather empirical in nature and optimized over years of application. This is particularly problematic when transitioning to new technologies for which too few empirical values are available.

### SUMMARY

The subject-matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that reference is always or can always be made to the individual aspects of the disclosure with respect to the disclosure.

The object of the disclosure is in particular a method for determining system excitation by at least one input signal for model-based control of a technical system, comprising the following steps, wherein the steps can be repeated and/or carried out sequentially.

In a first step, in particular, the at least one input signal is provided, wherein the at least one input signal physically affects at least one parameter of the technical system. For example, the input signal may be an electric voltage or motor torque. The input signal may also be referred to and understood as an input variable in the context of the present disclosure. One possible parameter of the technical system is, for example, an inertia of a motor.

In a further step, preferably at least one distribution assumption is defined for the at least one parameter. In one example, the distribution assumption may be a uniform distribution having a lower and upper bound. As a result, existing knowledge about the at least one parameter can be advantageously taken into account and the method thus allows a more precise optimization of the at least one input signal.

In a further step, a target function for an optimization of the at least one input signal may be defined, taking into account the at least one defined distribution assumption. The target function may optimize the at least one input signal at least based on a weighting of a sensitivity of the input signal. Further, the target function may optimize a ratio between the weighting of sensitivity and a weighting of the input signal itself, that is, a level of voltage if the input signal is an electrical voltage. As part of the present step, optionally by way of the method of intrusive polynomial chaos development (IPCE), an independent surrogate model may be determined, the initial parameters thereof directly being sensitivity measures.

In a further step, in particular, a numerical algorithm for solving the defined target function and an uncertainty quantification method for determining the sensitivity of the at least one input signal is determined. For the numerical algorithm, gradient-based methods such as interior point methods or trust region algorithms, or global optimization methods such as simulated annealing or genetic algorithms, may be determined. Sampling-based methods, for example Monte Carlo, Latin Hypercube, or an intrusive uncertainty quantification method may be used for the uncertainty quantification method. For example, the numerical algorithm and the uncertainty quantification method may be determined depending on a type of the technical system.

In a further step, preferably the defined target function is optimized based on the determined numeric algorithm and the determined uncertainty quantification method. For example, the optimization may be a maximization or a minimization of the target function.

In a further step, in particular, the system excitation is determined based on the optimized target function.

The at least one distribution assumption preferably provides at least one maximum value and/or a minimum value for the at least one parameter and/or at least one property for an allowability of the at least one input signal. For example, the property for the allowability of the at least one input signal may be an amplitude or slope constraint or another differentiability characteristic.

Further, the sensitivity particularly describes a ratio for a change in the at least one parameter of the technical system as a function of a change in the at least one input signal. Put simply, the sensitivity describes in particular how much said output variable of the corresponding parameter changes when the input signal is changed.

A further advantage in the context of the disclosure is achievable if, as part of defining the at least one target function, it is established whether the sensitivity is minimized or maximized for the at least one parameter of the technical system. As a result, depending on the given application, a minimization or maximization of the sensitivity for the at least one parameter can advantageously be carried out.

Also, it is optionally contemplated that defining the at least one target function further comprises the following step:
weighting the at least one input signal to carry out the optimization of the defined target function further taking into account the weighting of the at least one input signal.
   Optimizing the defined target function, taking into account the weighting of the at least one input signal, is preferably carried out in such a way that the input signal mathematically leads to a penalty. In particular, the optimization of the defined target function can thus be carried out on the basis of a ratio between the weighting of the sensitivity and the weighting of the input signal, for example in terms of a quality measure. A high degree of quality g preferably results from a high sensitivity and a low signal strength of the input signal.

It may optionally be possible that optimizing the defined target function further comprises the following step:
determining at least one degree of freedom for the optimization, wherein the at least one degree of freedom describes at least one type of the input signal.
   For example, the type of input signal may be a signal structure. In simplified terms, the degrees of freedom are used to determine in particular what possibilities are available for optimizing the input signal. A free optimization of the input signal may be possible or only a parameter optimization for a given signal structure or given additional functions.

It may further be possible that the method further comprises the step of:
defining a termination criterion for the optimization of the defined target function, wherein the termination criterion indicates a threshold value for the sensitivity of the at least one input signal and/or a quantity of iterations for optimizing the defined target function.
   The optimization of the defined target function may be performed iteratively until the defined termination criterion has been met. Thus, it can be ensured that the sensitivity exceeds the threshold value and thus a correspondingly optimized system excitation is possible based on the input signal. Further, the quantity of iterations may advantageously adjust a computational requirement to a present application case or a present technical system.

It is optionally contemplated that the method further comprises the following step:
applying the determined system excitation to a technical system to perform a system identification of the technical system, wherein a value for the at least one parameter of the technical system is determined based on the determined system excitation.
   For example, the method may be used for system identification of steering systems for rack position control (RPC). The at least one input signal of the system excitation can be used to identify parameters on prototypical samples or in the context of an end-of-line test.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a technical system, a device, a storage medium, and a computer program according to exemplary embodiments of the disclosure.

FIG. 2 a schematic illustration of a method according to exemplary embodiments of the disclosure.

### DETAILED DESCRIPTION

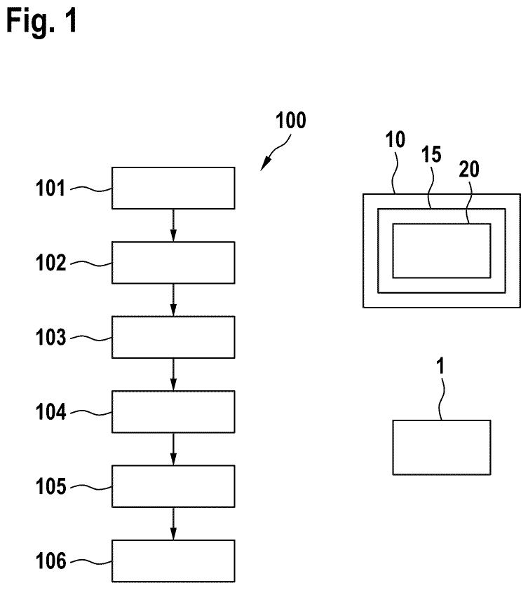

FIG. 1 schematically illustrates a method 100, a technical system 1, a device 10, a storage medium 15, and a computer program 20 according to exemplary embodiments of the disclosure.

FIG. 1 shows in particular an exemplary embodiment for a method 100 for determining system excitation by at least one input signal for model-based control of a technical system 1. In a first step 101, the at least one input signal is provided, wherein the at least one input signal physically affects at least one parameter of the technical system 1. In a second step 102, at least one distribution assumption is defined for the at least one parameter. In a third step 103, a target function for an optimization of the at least one input signal is defined taking into account the at least one defined distribution assumption, wherein the target function optimizes the at least one input signal based on a weighting of a sensitivity of the input signal. In a fourth step 104, a numerical algorithm for solving the defined target function and an uncertainty quantification method for determining the sensitivity of the at least one input signal are determined. In a fifth step 105, the defined target function is optimized based on the determined numeric algorithm and the determined uncertainty quantification method. In a sixth step 106, the system excitation is determined based on the optimized target function.

By way of the disclosure according to exemplary embodiments, it is in particular possible to determine system excitations tailored to identify specific unknown parameters of the technical system 1. This may be utilized to check a quantity of existing input signals for suitability for identifying said parameters. If the existing input signals are parameterizable, said degrees of freedom can be optimized for the current case. In addition, new optimal system excitations may be generated. The disclosure according to exemplary embodiments allows existing expert knowledge (for example in the form of a measurement catalog) to be used in particular when transferring to new application cases. In addition, the completeness of the measurement catalog can be verified by checking whether all relevant parameters are given sufficient excitation.

For example, as compared to the prior art, the disclosure offers the following advantages according to exemplary embodiments. Excitation signals for identifying particular model parameters may be generated in a manner targeted to the existing prior knowledge of the technical system. This includes in particular maximizing the sensitivity of the parameters to be identified as well as minimizing the influence of other parameters intended to influence the estimation result as little as possible. Existing expert knowledge (for example in the form of a “measurement catalog”) can be checked for suitability and completeness for identifying particular parameters. This may include the following: If degrees of freedom are present in existing excitation signals, then the same can be optimized for the existing systems. If particular parameters cannot be sufficiently identified by way of the existing excitation or input signals, then the measurement catalog can be systematically extended by specific optimal excitation signals. When transitioning to a different system (for example, a new product generation), an existing measurement catalog can be adapted to the new system. This supports, for example, the transfer of existing expert knowledge to new technologies. For special system classes, it is possible to solve a signal generation problem-similar to approaches to model predictive control. This allows, for example, online optimization or adaptivity to parameter fluctuations, provided the system allows a corresponding excitation during operation.

The disclosure according to exemplary embodiments is particularly relevant in the context of system identification as part of model-based control. The objective of the system identification is preferably to determine the parameters of a technical system 1. A systematic design or analysis of the system excitation used for this purpose is an aspect of the present disclosure according to exemplary embodiments. This is in particular a basis for model-based control.

A basis of the method according to exemplary embodiments is in particular the description of the system behavior by a model [symbol] establishing a connection between the system input u(t) ε [symbol] ^{m} to be designed, the measurement/output parameters y(t) ε [symbol] ^{q}, and the relevant parameters p ε [symbol] ⁿ.

$$y ( t ) = ( u ( t ) , p ) \qquad ( 1 )$$

If the model is [symbol] a dynamic state space model having internal states, further simplifications may be necessary, as described below. The parameters are preferably interpreted as uncertain quantities and are described by a probability assumption p˜Ω. In particular, without limiting generality, a uniform distribution p ε [symbol] (p⁻,p⁺) is set having upper and lower limits p⁻≤p≤p⁺ limiting the expected parameter range. For example, the target quantity of the optimization of the input quantity is based on a global sensitivity analysis of the measured quantities. The sensitivity Sᵢⱼ(t) of a starting variable y; with respect to the parameter pⱼ may be determined via a Sobol sequence:

$${S}_{i j} ( t ) = \frac{{var}_{{p}_{j}} [ {𝔼}_{{p}_{\sim j}} ( {y}_{i} \vert {p}_{j} ) ] ( t )}{var [ {y}_{i} ] ( t )} S ( t ) = vec ( {S}_{i j} ( t ) ) \qquad ( 2 )$$

Where ˜j particularly indicates all parameters except pⱼ. By way of example, the first order Sobol index is used as a sensitivity measure Sᵢⱼ. Other measures such as the total effect Sobol index are also possible. Various uncertainty quantification (UQ) sampling-based Monte Carlo simulations, Latin hypercube sampling, (adaptive) pseudo-spectral projections, or intrusive polynomial chaos development (IPCE) may be used to calculate the sensitivities according to equation (2) for a given input.

The determination of the input signal u(t) is carried out in particular via the optimal control problem

$${max}_{u ( t ) ∈ 𝕌 , t ∈ [ {t}_{0} {t}_{f} ]} J = {\int }_{{t}_{0}}^{{t}_{f}} g ( S ( t ) , u ( t ) ) dt , s . t . ( 1 ) , ( 2 ) , p ∈ 𝒰 ( {p}^{-} , {p}^{+} ) \qquad ( 3 )$$

In particular, the optimal input signal is determined by optimizing a target function, in particular by maximizing the integral grade measure g as a function of the sensitivity S and the input u. One potential target function, in particular in the form of a grade gauge g, may have the following structure:

$$g ( S , u ) = {‖ S ‖}_{Q}^{2} - ϵ {‖ u ‖}_{R}^{2} \qquad ( 4 )$$

In particular, the first term represents the optimization of the sensitivity, for example by way of the weighted square standard. The diagonal entries of the matrix Q, can be used to select whether particular parameters are to be maximized (Qᵢᵢ>0) or minimized (Qᵢᵢ<0). A selection of the non-diagonal entries Qⱼᵢ=Qᵢⱼ<0 different from zero may still be used to penalize the maximization of different sensitivity levels at the same time. If several measured variables q≥1 are present, the sensitivity values S_{i,(·)} may be weighted. The second summand in equation (4) allows in particular the penalizing of the signal energy of the input signal, for example via a weighting matrix R. Further, the quantity [symbol] preferably describes the allowable input signals. This may include, for example, amplitude or slope constraints or other differentiability characteristics:

$$𝕌 = \{ u ( \cdot ) ∈ {𝒞}^{2} ( [ {t}_{0} , {t}_{f} ] ) \vert {u}^{-} \leq u ( t ) \leq {u}^{+} , {\dot{u}}^{-} \leq \dot{u} ( t ) \leq {\dot{u}}^{+} , ∀ t ∈ [ {t}_{0} , {t}_{f} ] \} , \qquad ( 5 )$$

If there is a parameterizable signal structure u(t,θ) having degrees of freedom θ, for example as a linear combination u(t)=Σᵢθᵢuᵢ⁰(t), then the optimization problem may be carried out according to equation (3) directly via the degrees of freedom θ instead of via the time function u(t).

For certain model classes according to equation (1) of linear and non-linear dynamic systems, the sensitivity measures may be determined particularly efficiently by intrusive UQ methods. This in particular allows real-time implementation of the method according to exemplary embodiments and is shown using the example of a linear state space model:

$$\dot{x} ( t ) = A ( p ) x ( t ) + B ( p ) u ( t ) + w ( p ) t > {t}_{0} , x ( {t}_{0} ) = {x}_{0} ( p ) y ( t ) = C ( p ) x ( t ) + D ( p ) u ( t ) . \qquad ( 6 )$$

By way of the method of intrusive polynomial chaos development (IPCE), an independent surrogate model can be determined, the initial parameters thereof directly being sensitivity measures according to equation (2)

$$\dot{X} ( t ) = {A}^{′} X ( t ) + {B}^{′} u ( t ) + {W}^{′} t > {t}_{0} , x ( {t}_{0} ) = {X}_{0} S ( t ) = V X ( t ) \qquad ( 7 )$$

This enables, for example, determining the sensitivity by way of only one simulation of the surrogate model according to equation (7), and determining the potentially computationally complex determination of the matrices A′, B′, W′, V′ as part of a pre-processing step. In particular, at the time of optimization no sampling-based methods for determining the sensitivity measures S(t) need to be performed.

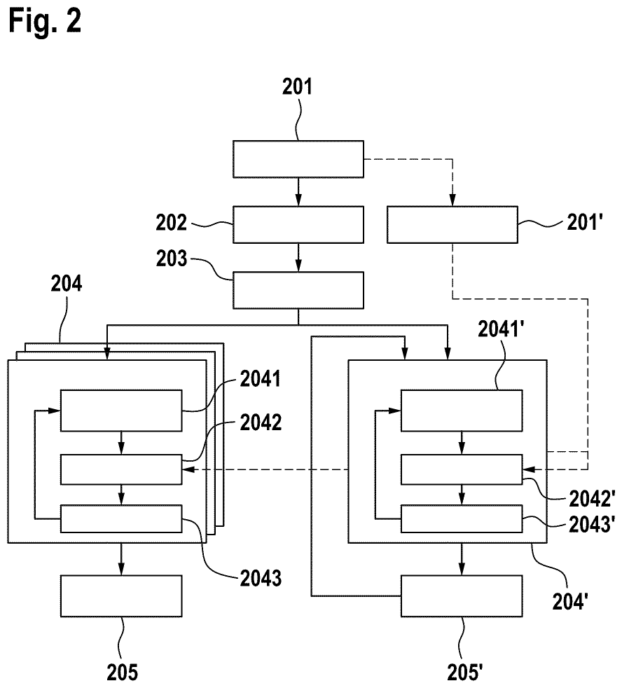

Optimal input signals are determined according to an exemplary embodiment by the following steps, as illustrated in FIG. 2. In a first step 201, distribution assumptions of the at least one parameter of the technical system 1 are defined. This includes, for example, probability measures of the parameters to be considered, for example expected maximum or minimum values, and/or defining allowable excitations, for example a quantity of the permitted input signals according to equation (5), and/or optionally, according to step 201′, determining the surrogate model, for example equation (7), provided that a suitable system class is present, for example equation (6). In a second step 202, a target function of the optimization is defined, for example in the form of equation (4). A weighting of the sensitivity is determined, that is, in particular a definition is provided of for which parameters the sensitivity should be maximized or minimized (cf. weighting matrix Q). If multiple parameters are to be identified by way of one system excitation, said parameters may be identified either together by way of one or by way of separate input signals. The latter, in particular, way that the further steps 203 to 205 are performed in sequence a plurality of times for each configuration. Further, a weighting is performed of the input signal, for example via a weighting matrix. In a third step 203, degrees of freedom of the optimization are defined, in particular a time horizon of the optimization problem and a type of the input signal, that is, whether a free optimization of the input signal or a parameter optimization is carried out for a given signal structure or for given starting functions. In a fourth step 204 according to a first alternative, the optimization problem is solved according to equation (3). A numerical algorithm is determined in 2041, for example gradient-based methods such as interior point methods or trust region algorithms, or global optimization methods such as simulated annealing or genetic algorithms. Further, an uncertainty quantification (UQ) method is determined 2042 for ascertaining the sensitivity measures according to equation (2) for an input signal determined by the numerical algorithm. Sampling-based methods, for example Monte Carlo, Latin hypercube, or an intrusive UQ method may be used. If a surrogate model was determined in step 1, then the sensitivity measures may be determined directly via the intrusive UQ method. Further, in the present step, the optimization problem is iteratively solved according to equation (3) by way of the numerical algorithm determined thereby and the uncertainty quantification method until a termination criterion is reached 2043. In a fifth step 205, the input signal(s) may be applied to the technical system 1.

If optimization is to be performed in real time, according to a second alternative, an iterative sequence of steps 204′, having steps 2041′, 2042′, and 2043′, as well as step 205′ may be provided. In this case, preferably the system response of the last cycle is used as the initial value 0 or 0 of the next iteration.

The disclosure may be used in any technical context underlying a model-based control function. One potential application case is in particular the identification of the parameters in the steering system, that is, for rack position control, for example for steer-by-wire systems. According to equation (1), the model in particular depicts the connection of motor torque to the position of the rack or to the motor angle.

Another potential application case is to identify the transverse and/or longitudinal guidance behavior of vehicles. Here, for example, the steering angle and desired acceleration are input signals and the yaw rate, float angle, or vehicle position and speed are relevant parameters. Further possible application cases are (large-area) robotics or the control of electrical machines.

The above explanation of the embodiments describes the present disclosure solely within the scope of examples. Of course, individual features of the embodiments may be freely combined with one another, if technically feasible, without leaving the scope of the present disclosure.

What is claimed is:

1. A method for determining system excitation by at least one input signal for model-based control of a technical system, comprising:
providing the at least one input signal, wherein the at least one input signal physically affects at least one parameter of the technical system;
defining at least one distribution assumption for the at least one parameter;
defining a target function for optimizing the at least one input signal taking into account the at least one defined distribution assumption, the target function optimizing the at least one input signal at least based on a weighting of a sensitivity of the input signal;
determining a numerical algorithm for solving the defined target function and an uncertainty quantification method for determining the sensitivity of the at least one input signal;
optimizing the defined target function based on the determined numerical algorithm and the determined uncertainty quantification method; and
determining the system excitation based on the optimized target function.

2. The method according to claim 1, wherein:
the at least one distribution assumption specifies at least one maximum value and/or a minimum value for the at least one parameter and/or at least one property for an allowability of the at least one input signal, and/or
the sensitivity describes a ratio for a change in the at least one parameter of the technical system as a function of a change in the at least one input signal.

3. The method according to claim 1 wherein:
in the context of defining the at least one target function, it is established whether the sensitivity for the at least one parameter of the technical system is minimized or maximized.

4. The method according to claim 1, wherein defining the at least one target function further comprises:
weighting the at least one input signal to perform the optimization of the defined target function, further taking into account the weighting of the at least one input signal.

5. The method according to claim 1, wherein:
optimizing the defined target function further comprises determining at least one degree of freedom for the optimization, and
the at least one degree of freedom describes at least one type of the input signal.

6. The method according to claim 1, further comprising defining a termination criterion for optimizing the defined target function, wherein:
the termination criterion indicates a threshold value for the sensitivity of the at least one input signal and/or a quantity of iterations for optimizing the defined target function, and
optimizing the defined target function is performed iteratively until the defined termination criterion is met.

7. The method according to claim 1, further comprising applying the determined system excitation to a technical system to perform a system identification of the technical system,
wherein a value for the at least one parameter of the technical system is determined based on the determined system excitation.

8. A computer program, comprising instructions which, when the computer program is executed by a computer, cause the latter to execute the method according to claim 1.

9. A device for data processing, configured to carry out the method according to claim 1.

10. A computer-readable storage medium, comprising instructions which, when executed by a computer, cause said computer to carry out the steps of the method according to claim 1.
